(19) United States
(12) Patent Application Publication
(10) Pub. No.: US 2018/0093447 A1
(43) Pub. Date: Apr. 5, 2018

(54) STRUCTURE MADE OF MULTILAYER MATERIAL WITH INCREASED LIGHTNESS AND CORRESPONDING OBTAINABLE MANUFACTURED ARTICLE

(71) Applicant: GIEMME S.A.S. DI CORRADINI MARCO & C., Campogalliano (IT)

(72) Inventors: Marco CORRADINI, Campogalliano (IT); Vyacheslav YAZON, Campogalliano (IT); Mark Jonathan GRIX, Burnham On Crouch (GB); Michael Ian BIRRELL, Guilden Morden (GB)

(73) Assignee: GIEMME S.A.S. DI CORRADINI MARCO & C., Campogalliano (IT)

(21) Appl. No.: 15/725,740

(22) Filed: Oct. 5, 2017

(30) Foreign Application Priority Data
Oct. 5, 2016 (IT) 102016000099626

(51) Int. Cl. B32B 5/12; B32B 27/08; B32B 27/32; B29C 51/14

(52) U.S. Cl. CPC B32B 5/12; B32B 27/08; B32B 27/32; B29K 2023/12; B32B 2260/048; B32B 2605/00; B29C 51/14

(57) ABSTRACT

A structure made of multilayer material with increased lightness, of the type comprising a plurality of layers superimposed in pairs which adhere to each other, comprising a first layer and a second layer made of composite material that comprises a thermoplastic polymeric matrix loaded with reinforcement fibers between which at least one layer of fabric made of synthetic fibers is interposed.

The present invention relates to a structure made of multilayer material with increased lightness and a corresponding obtainable manufactured article.

The use is known of partition walls, known as “bulkheads”, with a structural and safety function, for dividing the inner spaces of vehicles.

For example, in the sector of building motor vehicles for transporting goods and materials, such as ordinary vans, it is known to provide a bulkhead that separates the cargo compartment from the driver's cab and protects the driver and any passengers in the event of an accident or of a sudden braking, by preventing the loaded materials from invading the driver's cab.

Such bulkhead needs to have adequate characteristics of resistance to shocks in order to perform such task.

For this reason such bulkheads are generally made of sheet metal of suitable thickness and are made in the desired shape.

These conventional bulkheads are not devoid of drawbacks, among which is the fact that they are rather heavy, thus considerably increasing the overall weight of the vehicle on which they are mounted and the corresponding consumption of fuel.

Furthermore, the weight of such bulkheads complicates their logistical management and movement during the construction of the vehicles.

Last but not least, the necessity of mechanically deforming the sheet metal in order to obtain a bulkhead limits the variety of three-dimensional outlines that can be obtained and can require the execution of successive machining steps.

Also, if one needs to obtain a certain degree of acoustic insulation of one compartment with respect to the other, additional materials need to be provided and coupled to the sheet metal.

The aim of the present invention is to eliminate the above mentioned drawbacks in the background art, by providing a structure made of multilayer material with increased lightness and a corresponding obtainable manufactured article that make it possible to obtain high levels of mechanical strength with a reduced specific weight.

Within this aim, an object of the present invention is to be workable by way of thermoplastic deformation techniques, so as to be versatile in use and permit the production of manufactured articles that have various different shape structures in a single processing step.

Another object of the present invention is to make it possible to produce bulkheads for vehicles of reduced weight, so as to simplify the mounting thereof and not penalize the overall weight and fuel consumption of such vehicles.

Another object of the present invention is to provide a simple structure which is easy and practical to implement, safe in use and effective in operation, and low cost.

This aim and these and other objects which will become better apparent hereinafter are all achieved by the present structure made of multilayer material with increased lightness, of the type comprising a plurality of layers superimposed in pairs which adhere to each other, characterized in that it comprises a first layer and a second layer made of composite material that comprises a thermoplastic polymeric matrix loaded with reinforcement fibers, between which at least one layer of fabric made of synthetic fibers is interposed.

Likewise, this aim and these objects are achieved by the present manufactured article obtainable by way of thermoforming the structure made of multilayer material according to the invention.

Further characteristics and advantages of the present invention will become better apparent from the detailed description of two preferred, but not exclusive, embodiments of a structure made of multilayer material with increased lightness and corresponding obtainable manufactured article, which are illustrated for the purposes of non-limiting example in the accompanying drawings wherein:

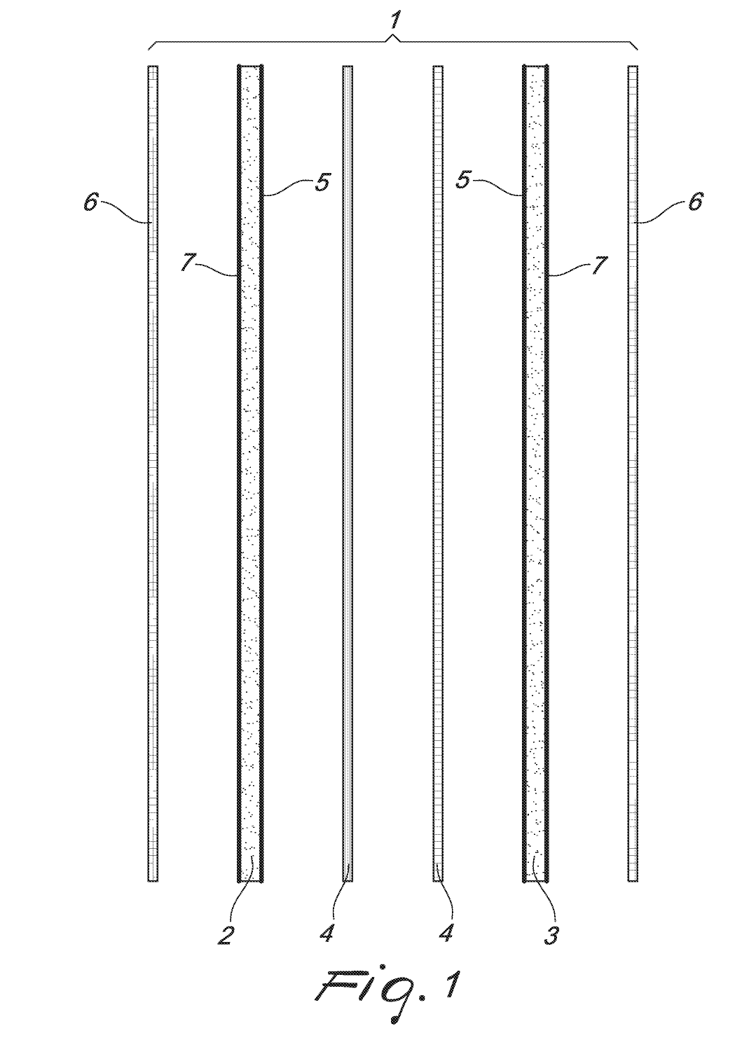

FIG. 1 is a cross-sectional view of a first embodiment of a structure made of multilayer material with increased lightness, according to the invention;

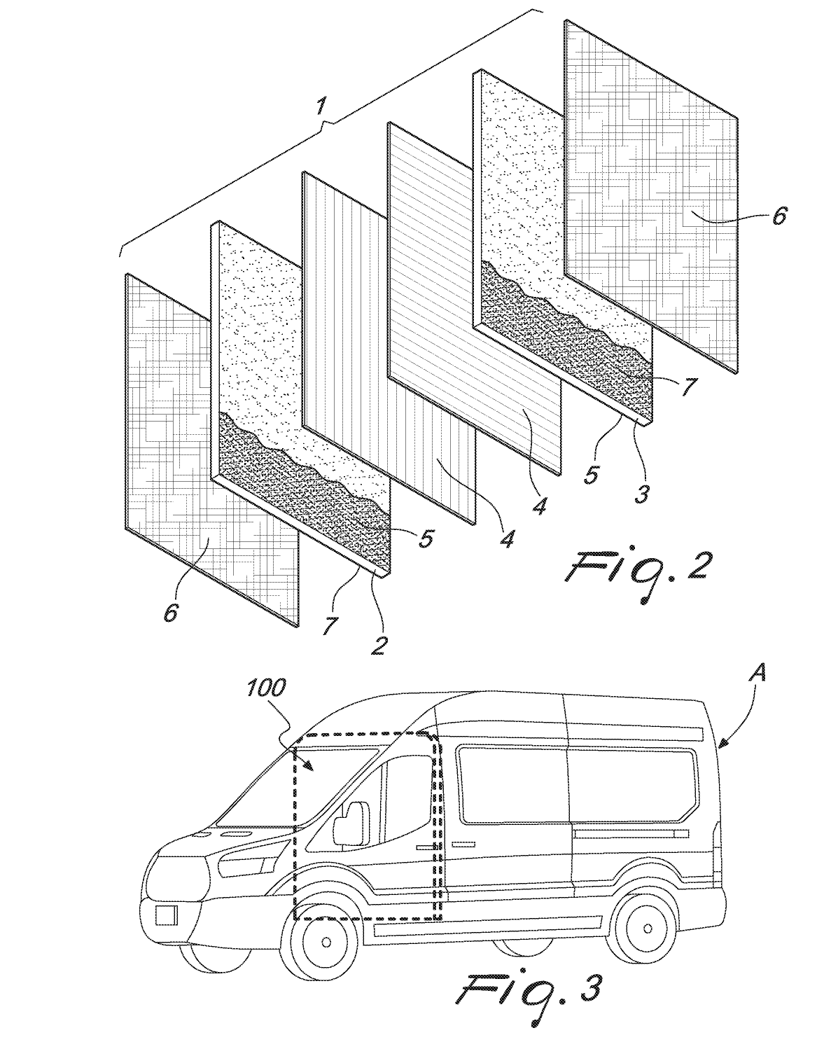

FIG. 2 is a schematic perspective view of the structure made of multilayer material according to the invention;

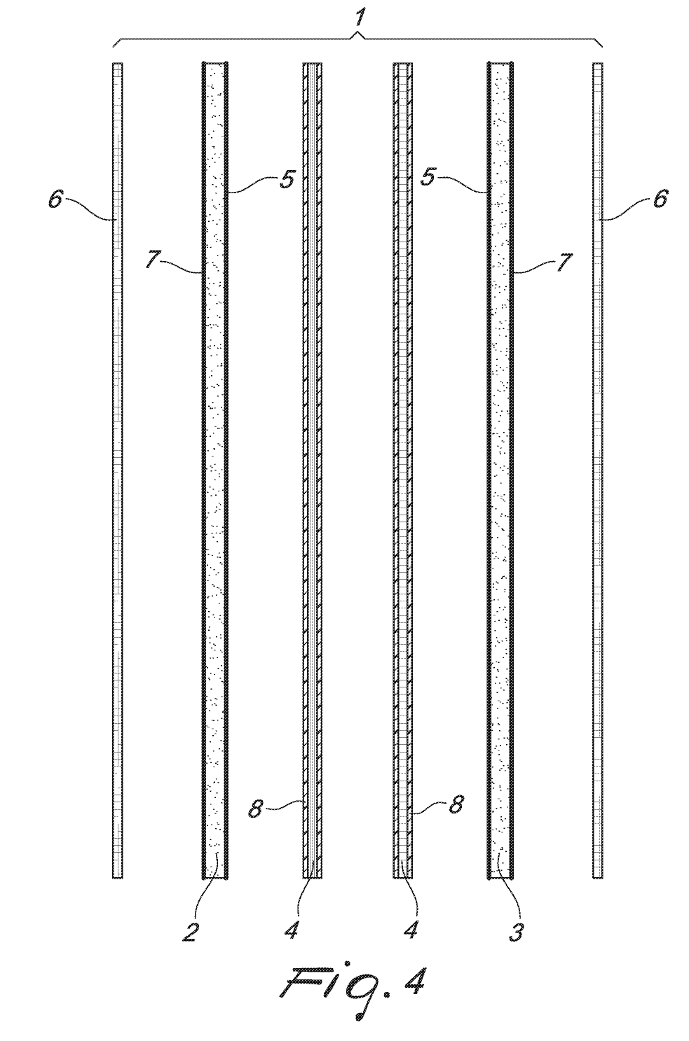

FIG. 3 is a perspective view of a manufactured article obtainable with the material according to the invention of the type of a bulkhead for motor vehicles for transporting goods;

FIG. 4 is a cross-sectional view of a second embodiment of a structure made of multilayer material, according to the invention.

With reference to the figures, the reference numeral 1 generally designates a structure made of multilayer material with increased lightness.

The structure 1 is of the type comprising a plurality of layers of different materials superimposed in pairs which adhere to each other.

The structure 1 comprises a first layer and a second layer, respectively 2 and 3, made of composite material that comprises a thermoplastic polymeric matrix loaded with reinforcement fibers between which at least one layer of fabric 4 made of synthetic fibers is interposed.

The first and the second layer 2 and 3 give the material structure, acting as a “reinforcement” for the at least one layer of fabric 4, which confers resistance to stresses transverse to the arrangement of such layers.

It should be noted that the term “synthetic fibers” generically means artificial fibers made by way of adapted chemical processes or reactions, such as in particular synthetic fibers derived from synthetic polymers (for example aramid fibers) or inorganic fibers derived from minerals or inorganic substances (for example carbon fibers and glass fibers).

The thermoplastic polymeric matrix that constitutes the first and the second layer 2 and 3 comprises, preferably, polypropylene, compounds thereof or derivatives thereof.

The reinforcement fibers provided in the first and in the second layer 2 and 3 are, preferably, chosen from the group comprising aramid fibers, glass fibers and carbon fibers.

The first and the second layer 2 and 3 can have, as a function of the corresponding composition and thickness, a basis weight that can vary between 400 g/m² and 2000 g/m².

The layer of fabric 4 is preferably unidirectional, i.e. with fibers substantially arranged along a main direction. Therefore, in order to confer greater resistance to transverse stresses, two or more layers of fabric 4 that have their fibers oriented in different directions can be provided.

The figures show two layers of fabric 4 which have the respective fibers oriented in perpendicular directions.

Furthermore the layers of fabric 4 can be impregnated with a thermoplastic polymeric material that is chemically compatible with the thermoplastic polymeric matrix of the layers 2 and 3, so as to obtain a mutual cohesion of the layers if subjected to hot-pressing. The thermoplastic polymeric material with which the layers of fabric 4 are impregnated is, preferably, polypropylene, compounds thereof or derivatives thereof.

In an alternative embodiment (FIG. 4) the layers of fabric 4 are embedded in respective layers 8 made of a thermoplastic material that is chemically compatible with the thermoplastic polymeric matrix of the layers 2 and 3, so as to obtain a mutual cohesion of the layers if subjected to hot-pressing.

Preferably also the layers 8 are made of polypropylene, compounds thereof or derivatives thereof.

Coupling thermoplastic polymeric material to the fabric made of synthetic fibers makes it possible to obtain a cohesion of the layers 2, 3 and 8 as a result of hot-pressing.

In this manner, by way of thermoforming processes it is possible to obtain a complete and stable adhesion of the layers 2, 3, 8-4, while maintaining a good level of deformability of the material, also in order to obtain complex three-dimensional shapes.

Between the first and the second layer 2 and 3 and the layers of fabric 4, a layer of thermoplastic adhesive 5 is preferably provided, polypropylene- or multilayer-based, continuous or with openings that further facilitate the cohesion of the layers.

Furthermore, the structure 1 can have at least one covering layer 6 coupled to at least one of the first and the second layer 2 and 3 by the interposition of a layer of thermoplastic adhesive 7, polypropylene- or multilayer-based, continuous or with openings that facilitate the cohesion of the layers.

The covering layer 6 can be constituted, for example, by fabric, film or scrim made of various different materials.

In the figures, each one of the layers 2 and 3 is coupled externally to a covering layer 6 by the interposition of a respective layer of adhesive 7.

The structure 1 made of composite material described above is particularly adapted to be worked by way of conventional techniques of thermoforming by molding, or any other technology that employs the action of pressure and heat in order to obtain the adhesion and the deformation of the layers so as to obtain a finished or semi-finished manufactured article.

For example, the method of working the structure 1 can entail an initial preheating of the first and of the second layer 2 and 3 with one or more layers of fabric 4 interposed, optionally incorporated in respective layers 8, up to a temperature comprised between 150° C. and 250° C., loading such juxtaposed layers into a thermoforming mold together with the pre-tensioned covering layers 6, closing the mold, and maintaining compression for a time that can vary from 30 seconds to 80 seconds as a function of the basis weight of the materials employed.

The manufactured article thus obtained can be either finished and ready for use, or semi-finished and be sent for further processing (for example cutting or blanking).

In particular, by way of thermoforming the structure 1 made of composite material described above, bulkheads and panels for various applications can be obtained.

Advantageously, by way of thermoforming the structure 1 made of composite material described above, a bulkhead 100 can be obtained that is intended to be mounted on a motor vehicle A adapted to transport goods and materials, in order to separate the cargo compartment and the driver's cab (FIG. 3).

In this case, the bulkhead 100 enables a considerable weight reduction compared to traditional metal bulkheads and it can be shaped at will with adapted thermoforming molds.

Furthermore the materials employed also confer excellent thermal and acoustic insulation characteristics on the bulkhead 100.

In practice it has been found that the invention as described achieves the intended aim and objects and, in particular, attention is drawn to the fact that the structure made of composite material according to the invention makes it possible to obtain manufactured articles that are light, easily managed in terms of logistics, and workable by way of conventional thermoforming techniques in order to obtain a wide variety of three-dimensional outlines.

The invention, thus conceived, is susceptible of numerous modifications and variations, all of which are within the scope of the appended claims.

Moreover, all the details may be substituted by other, technically equivalent elements.

In practice the materials employed, as well as the contingent dimensions and shapes, may be any according to requirements without for this reason departing from the scope of protection claimed herein.

The disclosures in Italian Patent Application No. 102016000099626 (UA2016A007081) from which this application claims priority are incorporated herein by reference.

What is claimed is:

1. A structure made of multilayer material with increased lightness, of the type comprising a plurality of layers superimposed in pairs which adhere to each other, further comprising a first layer and a second layer made of composite material that comprises a thermoplastic polymeric matrix loaded with reinforcement fibers, between which at least one layer of fabric made of synthetic fibers is interposed.

2. The structure according to claim 1, wherein said thermoplastic polymeric matrix comprises polypropylene, compounds thereof or derivatives thereof.

3. The structure according to claim 1, wherein said reinforcement fibers are chosen from the group comprising glass fibers, carbon fibers, and aramid fibers.

4. The structure according to claim 1, wherein said synthetic fibers are chosen from the group comprising glass fibers, carbon fibers, and aramid fibers.

5. The structure according to claim 1, wherein said layer of fabric is unidirectional.

6. The structure according to claim 5, further comprising a plurality of said layers of fabric arranged with the corresponding synthetic fibers oriented in different directions.

7. The structure according to claim 1, wherein said at least one layer of fabric is impregnated with a thermoplastic polymeric material that is chemically compatible with said thermoplastic polymeric matrix so as to obtain a cohesion of said first and second layers and of said at least one layer of fabric as a result of hot-pressing.

8. The structure according to claim 7, wherein said thermoplastic polymeric material is polypropylene, compounds thereof or derivatives thereof.

9. The structure according to claim 1, wherein said at least one layer of fabric is embedded in a layer of thermoplastic polymeric material that is chemically compatible with said thermoplastic polymeric matrix so as to obtain a cohesion of said first and second layers and of said at least one layer of fabric (4) as a result of hot-pressing.

10. The structure according to claim 9, wherein said at least one layer comprises polypropylene, compounds thereof or derivatives thereof.

11. The structure, according to claim 1, wherein there is a respective layer of thermoplastic adhesive (5) between said first and second layers and said at least one layer of fabric.

12. The structure according to claim 1, further comprising at least one covering layer associated with at least one of said first and second layers by interposition of a respective thermoplastic adhesive layer.

13. A manufactured article obtainable by thermoforming the structure made of multilayer material according to claim 1.

14. Use of a structure made of multilayer material according to claim 1 for the provision by thermoforming of bulkheads for separating the loading compartment and the driver's cab of motor vehicles for the transport of goods and materials.
